(19) United States
(12) Patent Application Publication
(10) Pub. No.: US 2025/0192155 A1
(43) Pub. Date: Jun. 12, 2025

(54) ELECTRODE HETEROSTRUCTURES

(71) Applicant: Schlumberger Technology Corporation, Sugar Land, TX (US)

(72) Inventors: Javier Rubio Garcia, Cambridge (GB); Gema Cabello Carramolino, Cambridge (GB)

(21) Appl. No.: 18/947,234

(22) Filed: Nov. 14, 2024

Related U.S. Application Data
(60) Provisional application No. 63/606,613, filed on Dec. 6, 2023.

(51) Int. Cl. H01M 4/36; H01M 4/02; H01M 4/04; H01M 4/48; H01M 4/58; H01M 4/583; H01M 12/06

(52) U.S. Cl. CPC H01M 4/366; H01M 4/0428; H01M 4/483; H01M 4/5815; H01M 4/583; H01M 12/06; H01M 2004/021

(57) ABSTRACT

The present disclosure provides systems and methods of forming a nickel composite. The method includes producing a semi-conductive component having a crystalline structure. A plurality of atomic layers of the semi-conductive component are exfoliated. At least a layer of a conductive component is disposed between each atomic layer of the plurality of atomic layers of the semi-conductive component.

### CROSS-REFERENCE TO RELATED APPLICATIONS

The subject disclosure claims priority from U.S. Application No. 63/606,613, filed on Dec. 6, 2023, herein incorporated by reference in its entirety.

### BACKGROUND

Nickel composites are used as catalysts in various fields of interest, e.g., water splitting, ammonia cracking, or renewable energy resources. For renewable energy resources such as wind and solar to be competitive with traditional fossil fuels, large-scale energy storage systems are needed to mitigate their intrinsic intermittency. To build a large-scale energy storage, the cost and long-term lifetime are the utmost considerations. Currently, rechargeable batteries are implemented for large-scale energy storage due to the high capacity and highly reliable components of the batteries. One such battery includes Ni-H₂ batteries, which have a low capacity decay after over 30,000 cycles. Unfortunately, Ni-H₂ batteries implement nickel hydroxide/nickel oxyhydroxide as the redox couple, which has a complex crystalline structure that limits insertion and/or extraction of protons due to the pseudo-capacitive behavior that allows redox processes to occur at the surface of the electrode and/or at the near-surface of the electrode. Specifically, the limitation insertion and/or extraction of protons reduces a power output of the battery.

Nickel oxide also shows a wide band gap, e.g., the distance between the valence band of electrons and the conduction band of electrons. A wide band gap causes the nickel oxide to be a poor electron conductor, limiting the maximum electrode thickness as conductivity will be reduced for thicker cathodes. Indeed, a reduction in maximum electrode thickness can reduce the overall capacity of the Ni-H₂ battery.

Accordingly, an improved nickel composite implementing a heterostructure is needed.

### SUMMARY

The present disclosure provides nickel composites. The nickel composites comprising a conductive substrate; a first atomic layer of a semi-conductive component; a second atomic layer of the semi-conductive component; and a layer of a conductive component disposed between the first atomic layer and the second atomic layer.

The present disclosure also provides methods of forming nickel composites. The method includes producing a semi-conductive component having a crystalline structure. A first atomic layer of the semi-conductive component is exfoliated. A second atomic layer of the semi-conductive component is exfoliated. The first atomic layer and the second atomic layer are arranged with a layer of a conductive component. The layer of the conductive component is disposed between the first atomic layer and the second atomic layer.

The following description and the appended figures set forth certain features for purposes of illustration.

### BRIEF DESCRIPTION OF DRAWINGS

So that the manner where the above recited features may be understood in detail, a more particular description, briefly summarized above, may be had by reference to example aspects, some of which are illustrated in the appended drawings.

FIGS. 1A-1C depict a schematic of a battery according to embodiments of the present disclosure.

FIG. 2 depicts a schematic of a plurality of atomic sheets of a semi-conductive component according to embodiments of the present disclosure.

FIG. 3 depicts a schematic of a vertical heterostructure according to embodiments of the present disclosure.

FIG. 4 depicts a workflow of a method of forming a vertical cathode heterostructure according to embodiments of the present disclosure.

### DETAILED DESCRIPTION

One or more specific embodiments of the present disclosure will be described herein. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure relates to systems and methods of nickel composites. The nickel composites may include electrode heterostructures. The electrode heterostructures may include a vertical cathode heterostructure. As used herein, a “vertical heterostructure” includes a heterostructure including alternating layers of semi-conductive and/or conductive layers extending along an axis, e.g., x, y, or z. The vertical cathode heterostructures may implement a plurality of atomic sheets of a semi-conductive component and/or a conductive component, increasing the overall surface area of the cathode that is exposed to an electrolyte located in a separator. Without being bound by theory, an increase in the overall surface area of the cathode decreases the distance of proton diffusion, which increases power output, e.g., the amount of current the battery can provide for a period of time, e.g., seconds, minutes, hours, days, or years. The vertical cathode heterostructures include alternating a plurality of atomic sheets of a semi-conductive component and with a plurality of conductive components to increase the maximum thickness of the cathode, without being bound by theory, an increase in the maximum thickness of the cathode increases the energy density, e.g., the amount of energy that can be stored in a battery per unit volume.

The present disclosure may include a battery including an electrode composite. The battery can include one or more of an aluminum ion battery, calcium battery, vanadium redox battery, zinc-bromine battery, zinc-cerium battery, hydrogen-bromine battery, lead-acid battery, magnesium ion battery, germanium-air battery, calcium-air battery, iron-air battery, potassium-ion battery, silicon-air battery, zinc-air battery, tin-air battery, sodium-air battery, beryllium-air battery, nickel-cadmium battery, nickel-iron battery, nickel-lithium battery, metal hydrogen battery, such as a nickel-metal hydride battery, nickel zinc battery, polymer-based battery, polysulfide-bromide battery, potassium-ion battery, silver-zinc battery, silver-cadmium battery, silver-calcium battery, sodium-ion battery, sodium-sulfur battery, or zinc-ion battery. In one embodiment, the battery includes a metal-hydrogen battery.

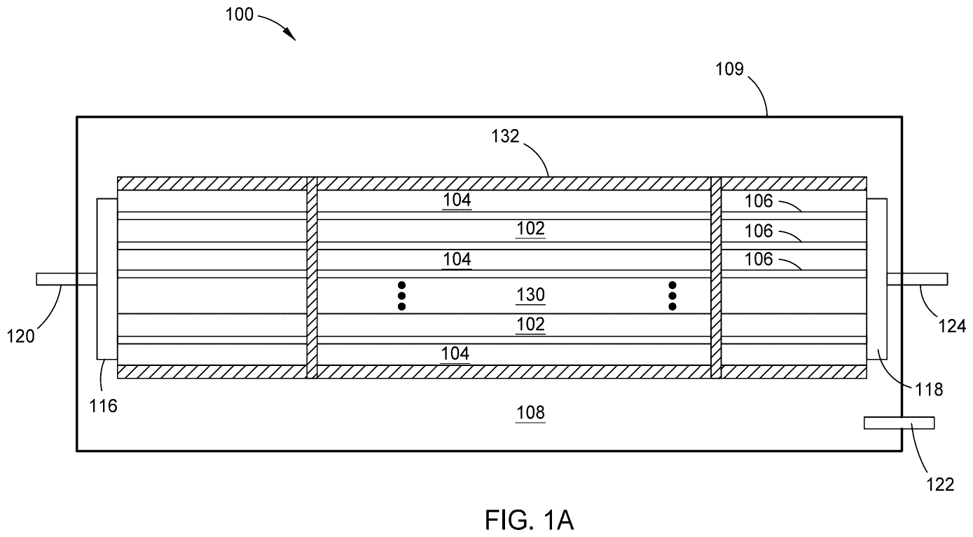

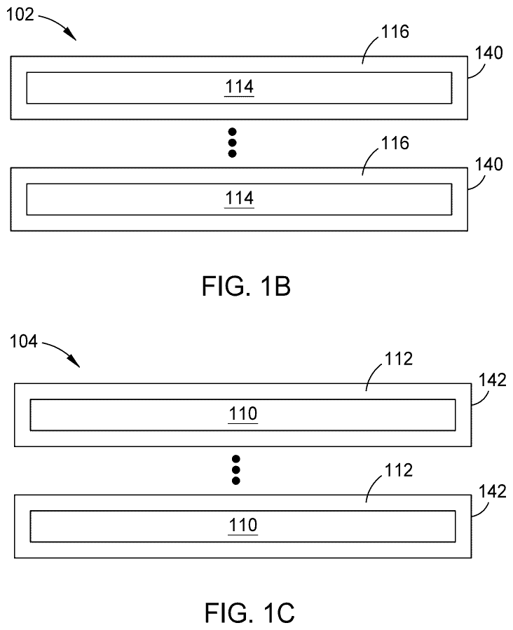

Now referring to FIG. 1A, a schematic depiction of a metal-hydrogen battery 100 is depicted. The metal-hydrogen battery 100 includes an electrode stack assembly 130 that includes stacked electrodes that are separated by separators 106. The electrode stack assembly 130 includes alternately stacked cathode electrodes 102 and anode electrodes 104 as illustrated in FIG. 1A. The cathode electrodes 102 and the anode electrodes 104 are separated by separators 106 that are disposed between them. The separator 106 can be saturated with an electrolyte 108. In some embodiments, the separator 106 also provides a reservoir of electrolyte 108 that buffers the electrodes from either drying out or flooding during operation of the battery 100. In some embodiments, the electrolyte 108 is an aqueous electrolyte. The aqueous electrolyte is alkaline and has a pH greater than 7, such as about 7.5 or greater, about 8 or greater, about 8.5 or greater, or about 9 or greater, or about 11 or greater, or about 13 or greater. As a non-limiting example, the electrolyte 108 may include KOH or NaOH or Li OH or a mixture of LiOH, NaOH and/or KOH.

The electrode stack assembly 130 can be housed in a pressure vessel 109. As illustrated, an electrolyte 108 is disposed in the pressure vessel 109 such that the stack 130 is saturated with the electrolyte 108. The cathode electrode 102, the anode electrode 104, and the separator 106 are porous to hold the electrolyte 108 and allow ions in the electrolyte 108 to transport between the cathode electrodes 102 and the anode electrodes 104. In some embodiments, the separator 106 can be omitted as long as the cathode electrodes 102 and the anode electrodes 104 can be electrically insulated from each other and the electrolyte 108 can be held in the electrode stack 130. For example, the space occupied by the separator 106 may be filled with the electrolyte 108.

The metal-hydrogen battery 100 can include a fill tube 122 configured to introduce electrolyte or gasses (e.g. hydrogen) into the pressure vessel 109. The fill tube 122 may include one or more valves (not shown) to control flow into and out of the enclosure of the pressure vessel 109 or the fill tube 122 may be otherwise sealable after charging the pressure vessel 109 with the electrolyte 108 and the hydrogen gas. Although FIG. 1A illustrates that the fill tube 122 is positioned on the side of the conductor 118, the fill tube 122 may alternatively be placed on the side of the conductor 116, or otherwise placed anywhere on the pressure vessel.

The electrode stack assembly 130 can include a number of stacked layers of alternating cathode electrodes 102 and anode electrodes 104 separated by separators 106. Although shown as being coupled in parallel in FIG. 1A, the electrodes in the electrode stack assembly 130 may be coupled either in parallel or in series. In particular, each of the cathode electrodes 102 are coupled to the conductor 118 and each of the anode electrodes 104 are coupled to the conductor 116. The electrode stack assembly 130 can be positioned in the pressure vessel 109 and contain the electrolyte 108, where ions in the electrolyte 108 can transport between cathode electrodes 102 and anode electrodes 104. The separator 106 can be a porous insulator. In some embodiments, the electrolyte 108 is an aqueous electrolyte that is alkaline (with a pH greater than 7).

The conductor 116, which is coupled to the anode electrodes 104, is electrically coupled to a terminal 120, which may present one terminal of battery 100. The terminal 120 can include a feedthrough to allow the terminal 120 to extend outside of the pressure vessel, or the conductor 116 may be connected directly to the pressure vessel 109 because the terminal 120 is coupled to the anode electrodes 104. Similarly, the conductor 118, which is coupled to the cathode electrodes 102, can be coupled to a terminal 124 that represents the opposite (positive) terminal of the battery 100. The terminal 124 can also pass through an insulated feedthrough to allow the terminal 124 to extend to the outside of the pressure vessel 109 because the terminal 124 is coupled to the cathode electrodes 104.

The electrode stack can be fixed within a frame 132. For example, the electrode stack assembly 130 can be organized with the anode electrodes 104 on both sides adjacent to the frame 132, in order to isolate the cathode electrodes 102 from the frame 132. In some embodiments, a separator 106 can be included adjacent to the frame 132 for further isolation, such as where the electrode stack assembly 130 is arranged such that the cathode electrodes 102 are adjacent to the frame 132 rather than the anode electrodes 104.

Now referring to FIG. 1B, a cathode electrode is illustrated. The cathode electrode 102 includes one or more atomic sheets 140 that are disposed on top of one another such that a layering of the atomic sheets 140 occurs. The atomic sheets 140 may include an atomic sheet 140 of one or more of a semi-conductive or a conductive component. For example, the atomic sheets 140 may include a semi-conductive component such as nickel oxyhydroxide or nickel hydroxide. Alternatively, the atomic sheet 140 may include a conductive component such as molybdenum disulfide. In an embodiment, the atomic sheets 140 may be a redox-reactive material that includes a transition metal, e.g., nickel, silver, cobalt, molybdenum, or manganese. In some embodiments, the transition metal can be cobalt. In some embodiments, cobalt is included as cobalt oxide or zinc cobalt oxide. In some embodiments, the transition metal can be manganese. In some embodiments, manganese can be included as manganese oxide or doped manganese oxide (e.g., doped with nickel, copper, bismuth, yttrium, cobalt or other transition or post-transition metals). Other transition metals are encompassed by this disclosure, such as silver. In some embodiments, the one or more atomic sheets may layer to produce a total thickness of about 0.1 nm to about 100 μm, e.g., about 0.1 nm to about 100 nm, about 100 nm to about 500 nm, about 500 nm to about 1 μm, about 1 μm to about 50 μm, or about 1 μm to about 10 μm.

In an embodiment, the atomic sheets 140 may include atomic sheets of nickel hydroxide or nickel oxyhydroxide. The atomic sheets 140 may be in a charged state or a discharged state. For example, where the atomic sheets 140 are nickel hydroxide, the nickel hydroxide may exist in discharged state such as β(II)-nickel hydroxide or α-nickel hydroxide. Alternatively, where the atomic sheets 140 are nickel oxyhydroxide, the nickel oxyhydroxide may exist in a charged state such as β(III)-nickel oxyhydroxide or γ-nickel oxyhydroxide. The atomic sheets 140 may be in an overcharged state where the β(III)-nickel oxyhydroxide is converted to γ-nickel oxyhydroxide, which has a higher average valence state compared to β(III)-nickel oxyhydroxide.

Each sheet of the plurality of atomic sheets may be separated by a distance of about 1 Å to about 100 Å, e.g., about 1 Å to about 20 Å, about 20 Å to about 30 Å, about 30 Å to about 40 Å, about 40 Å to about 50 Å, about 50 Å to about 60 Å, about 60 Å to about 70 Å, about 70 Å to about 80 Å, about 80 Å to about 90 Å, or about 90 Å to about 100 Å, between each atomic sheet of the plurality of atomic sheets. For example, where the atomic sheets 140 include atomic sheets of β(II)-nickel hydroxide the distance between each atomic sheet of the atomic sheets may be about 45 Å to about 47 Å, e.g., about 45 Å to about 45.5 Å, about 45.5 Å to about 46 Å, about 46 Å to about 46.5 Å, or about 46.5 Å to about 47. Å. As a further example, where the atomic sheets 140 include atomic sheets of β(III)-nickel oxyhydroxide the distance between each atomic sheet of the atomic sheets may be about 47 Å to about 49 Å, e.g., about 47 Å to about 47.5 Å, about 47.5 Å to about 48 Å, about 48 Å to about 48.5 Å, or about 48.5 Å to about 49 Å. As a further example, where the atomic sheets 140 include atomic sheets of γ-nickel oxyhydroxide the distance between each atomic sheet of the atomic sheets may be about 70 Å to about 80 Å, e.g., about 71 Å to about 72 Å, about 72 Å to about 73 Å, about 73 Å to about 74 Å, about 74 Å to about 75 Å, about 75 Å to about 76 Å, about 76 Å to about 77 Å, about 77 Å to about 78 Å, about 78 Å to about 79 Å, about 79 Å to about 80 Å. As a further example, where the atomic sheets 140 include atomic sheets of α-nickel hydroxide the distance between each atomic sheet of the atomic sheets may be about 80 Å to about 90 Å, e.g., about 81 Å to about 82 Å, about 82 Å to about 83 Å, about 83 Å to about 84 Å, about 84 Å to about 85 Å, about 85 Å to about 86 Å, about 86 Å to about 87 Å, about 87 Å to about 88 Å, about 88 Å to about 89 Å, about 89 Å to about 90 Å. Without being bound by theory, by layering each atomic sheet 140 of the plurality of atomic sheets such that each layer is separated by a distance, the surface area of the cathode may be increased such that a diffusion distance of protons is reduced during charging and/or discharging. By reducing the diffusion distance of protons an increase in the power output occurs as protons may be exchanged faster.

The plurality of atomic sheets 140 may coat and/or cover a conductive substrate 114. In some embodiments, the conductive substrate 114 is porous, such as having a porosity of at least about 10%, at least about 20%, at least about 30%, at least about 40%, or at least about 50%, and up to about 80%, up to about 90%, or greater. In some embodiments, the conductive substrate 114 can be formed of a metal foam, such as a nickel foam, or a metal alloy foam. Other conductive substrates are encompassed by this disclosure, such as metal foils, metal meshes, and fibrous conductive substrates. In an embodiment, the conductive substrate 114 may be a nickel mesh. In some embodiments, the conductive substrate 114 can be formed of carbon-based materials, such as carbon fibrous paper, carbon cloth, carbon felt, carbon mat, carbon nanotube film, graphite foil, graphite foam, graphite mat, graphene foil, graphene fibers, graphene film, and graphene foam.

In some embodiments, the anode electrode 104 may be a single-layer structure or a multilayer structure. In some embodiments, the anode electrode 104 can be formed with flat or with uneven surfaces. In some embodiments, multiple layers can be formed with a combination of flat and uneven circumstances surfaces. In some embodiments, the anode electrode 104 is a catalytic hydrogen electrode.

As illustrated in FIG. 1C, the anode electrode 104 can include one or more anode porous layers 142, each of the anode porous layers 142 include a porous conductive substrate 110 coated with a catalyst layer 112. The catalyst layer 112 can include a bi-functional catalyst to catalyze both hydrogen evolution reaction (HER) and hydrogen oxidation reaction (HOR) at the anode electrode 104. In some embodiments, the porous conductive substrate 110 has a porosity of at least about 10%, at least about 20%, at least about 30%, at least about 40%, or at least about 50%, and up to about 80%, up to about 90%, 95% or greater. In some embodiments, the porous conductive substrate 110 can be a metal foam, such as a nickel foam, an iron foam, a copper foam, a steel foam, or others. In some embodiments, the porous conductive substrate 110 is a metal alloy foam, such as a nickel-molybdenum foam, a nickel-iron foam, a nickel-copper foam, a nickel-cobalt foam, a nickel-tungsten foam, a nickel-silver foam, a nickel-molybdenum-cobalt foam, or others. Porous conductive substrate 110 can be formed of other conductive substrates, for example metal foils, metal meshes, and fibrous conductive substrates. In some embodiments, the conductive substrate 110 can be formed of carbon-based materials, such as carbon fibrous paper, carbon cloth, carbon felt, carbon mat, carbon nanotube film, graphite foil, graphite foam, graphite mat, graphene foil, graphene fibers, graphene film, and graphene foam.

In some embodiments, the bi-functional catalyst of the catalyst layer 112 can be a nickel-molybdenum-cobalt (NiMoCo) alloy. Other transition metal or metal alloys can be bi-functional catalysts, for example nickel, nickel-molybdenum, nickel-tungsten, nickel tungsten-cobalt, nickel-tungsten-copper, nickel-carbon, nickel-chromium, based composites. In some embodiments, bi-functional catalyst of catalyst layer 112 can include a transition metal alloy that includes two or more of Ni, Co, Cr, Mo, Fe, Mn, Cu, Zn, Sn, and W. Other precious metals and their alloys can also be included in bi-functional catalysts, for example platinum, palladium, iridium, gold, rhodium, ruthenium, rhenium, osmium, silver, and their alloys with precious and non-precious transition metals such as platinum, palladium, iridium, gold, rhodium, ruthenium, rhenium, osmium, silver, nickel, cobalt, manganese, iron, molybdenum, tungsten, chromium and so forth. In some embodiments, bifunctional catalysts of catalyst layer 112 can be a combination of HER and HOR catalysts. In some embodiments, the bi-functional catalysts of catalyst layer 112 can include a mixture of different materials, such as transition metals and their oxides/hydroxides, which contribute to hydrogen evolution and oxidation reactions as a whole. In some embodiments, the catalyst layer 112 includes nanostructures of the bi-functional catalyst having sizes (or an average size) in a range of, for example, about 1 nm to about 100 nm, about 1 nm to about 80 nm, or about 1 nm to about 50 nm. In some embodiments, the catalyst layer 112 includes microstructures of the bi-functional catalyst having sizes (or an average size) in a range of, for example, about 100 nm to about 500 nm, about 500 nm to about 1000 nm.

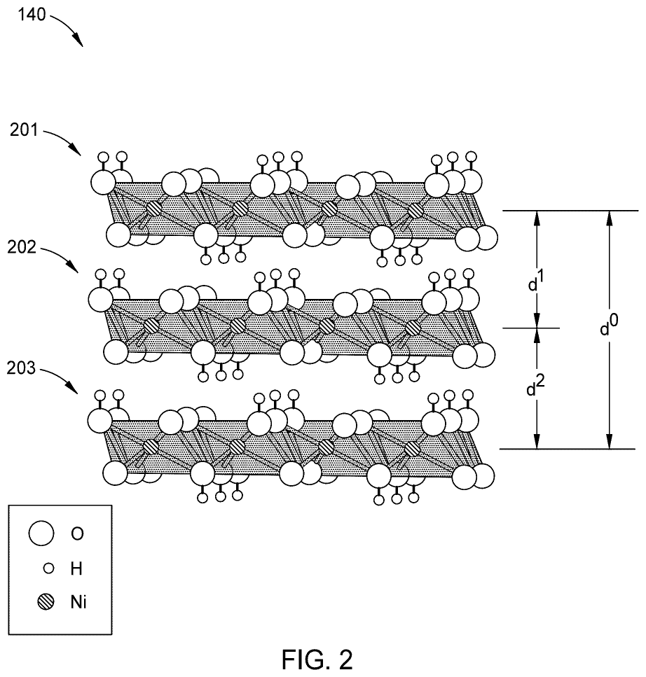

Now referring to FIG. 2, an embodiment of a plurality of atomic sheets 140 of a semi-conductive component is shown. The plurality of atomic sheets 140 can include a first layer 201 of a semi-conductive component. The first layer 201 of semi-conductive component can include a redox-reactive material that includes a transition metal, e.g., nickel, silver, cobalt, or manganese. In some embodiments, the transition metal can be cobalt. In some embodiments, cobalt is included as cobalt oxide or zinc cobalt oxide. In some embodiments, the transition metal can be manganese. In some embodiments, manganese can be included as manganese oxide or doped manganese oxide (e.g., doped with nickel, copper, bismuth, yttrium, cobalt or other transition or post-transition metals). Other transition metals are encompassed by this disclosure, such as silver. In an embodiment, the first layer 201 can include nickel hydroxide or nickel oxyhydroxide.

The plurality of atomic sheets 140 can include a second layer 202 of the semi-conductive component. The second layer 202 of the semi-conductive component can include a redox-reactive material that includes a transition metal, e.g., nickel, silver, cobalt, or manganese. In some embodiments, the transition metal can be cobalt. In some embodiments, cobalt is included as cobalt oxide or zinc cobalt oxide. In some embodiments, the transition metal can be manganese. In some embodiments, manganese can be included as manganese oxide or doped manganese oxide (e.g., doped with nickel, copper, bismuth, yttrium, cobalt or other transition or post-transition metals). Other transition metals are encompassed by this disclosure, such as silver. In an embodiment, the second layer 202 can include nickel hydroxide or nickel oxyhydroxide. The first layer 201 and the second layer 202 can be or have the same semi-conductive component, redox-reactive material, or transition metal.

The plurality of atomic sheets 140 can include a third layer 203 of the semi-conductive component. The third layer 203 of the semi-conductive component can include a redox-reactive material that includes a transition metal, e.g., nickel, silver, cobalt, or manganese. In some embodiments, the transition metal can be cobalt. In some embodiments, cobalt is included as cobalt oxide or zinc cobalt oxide. In some embodiments, the transition metal can be manganese. In some embodiments, manganese can be included as manganese oxide or doped manganese oxide (e.g., doped with nickel, copper, bismuth, yttrium, cobalt or other transition or post-transition metals). Other transition metals are encompassed by this disclosure, such as silver. In an embodiment, the third layer 203 can include nickel hydroxide or nickel oxyhydroxide. The first layer 201, the second layer 202, and the third layer 203 can be or have the same semi-conductive component, redox-reactive material, or transition metal.

Each of the first layer 201, second layer 202, and third layer 203 are separated by a distance. The first layer 201 may be separated from the second layer 202 by a distance “d¹”, where d¹ may range from about 10 Å to about 40 Å, e.g., about 10 Å to about 20 Å, about 20 Å to about 30 Å, or about 30 Å to about 40 Å. The second layer 202 may be separated from the third layer 203 by a distance “d²”, where d² may range from about 10 Å to about 40 Å, e.g., about 10 Å to about 20 Å, about 20 Å to about 30 Å, or about 30 Å to about 40 Å. In an embodiment, d¹ and d² are not the same. For example, the d¹ may be about 35 Å while d² may be about 40 Å. In an embodiment, d¹ and d² are the same. For example, d¹ and d² may both be about 35 Å. Without being bound by theory, by separating the first layer 201, second layer 202, and third layer 203 the surface area of the cathode may be increased such that a diffusion distance of protons is reduced during charging and/or discharging. By reducing the diffusion distance of protons an increase in the power output occurs as protons may be exchanged faster. In an embodiment, d¹ and d² may combine to provide a total thickness of the plurality of atomic sheets. The total thickness of the plurality of atomic sheets may be from about 0.1 nm to about 100 μm, e.g., about 0.1 nm to about 100 nm, about 100 nm to about 500 nm, about 500 nm to about 1 μm, about 1 μm to about 50 μm, or about 1 μm to about 10 μm.

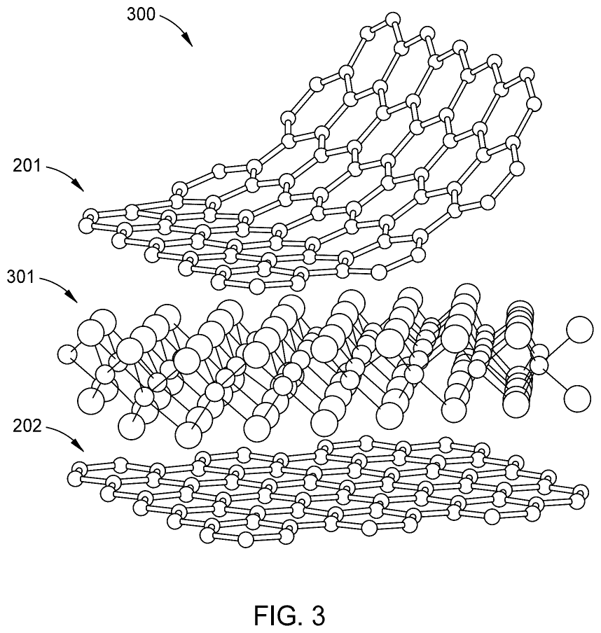

Now referring to FIG. 3, an embodiment of a vertical heterostructure 300 is shown. The vertical heterostructure 300 includes a conductive component disposed between a plurality of atomic layers of a semi-conductive component. For example, the vertical heterostructure 300 may include the first layer 201, where the first layer 201 is described above. The first layer 201 may be disposed over a second layer 301, where the second layer 301 is a conductive component. For example, the second layer 301 may include an atomic sheet of a transition metal complex having a thickness of about 10 Å to about 100 Å, e.g., 1T-molybdenum disulfide, graphene, titanium disulfide, boron nitride, silver sulfate, two-dimensional inorganic compounds that include atomically thin layers of transition metal carbides, carbonitrides, and/or nitrides, graphene, hexagonal boron nitride, or transition-metal dichalcogenides. As a further example, the second layer may include a layer of a transition metal complex having a thickness of about 10 Å to about 100 Å, e.g., molybdenum disulfide, graphene, titanium disulfide, boron nitride, or silver sulfate. The second layer 301 is disposed between the first layer 201 and a second layer 202, where the second layer 202 is described above. While only three layers are shown in FIG. 3, the vertical heterostructure may incorporate any number of atomic sheets 140 of semi-conductive components that alternate with the conductive component to produce a total thickness of about 0.1 nm to about 100 μm, e.g., about 0.1 nm to about 100 nm, about 100 nm to about 1 μm, about 1 μm to about 50 μm, or about 1 μm to about 10 μm. Without being bound by theory, the second layer 301 allows for thicker cathodes to be formed as the conductive component promotes proton exchange throughout the semi-conductive components. By increasing the thickness an increase of the energy density occurs as more charge may be stored within the battery 100.

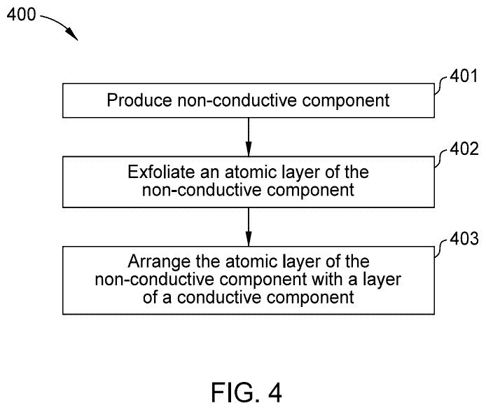

Now referring to FIG. 4, a method 400 of forming a vertical cathode heterostructure is shown. At step 401 a semi-conductive component is produced. The semi-conductive component is produced by mixing nickel acetate with oxalic acid to produce nickel oxalate. The nickel oxalate is then mixed with sodium hydroxide to produce Ni(OH)₂. Without being bound by theory, the semi-conductive component may be produced such that the semi-conductive component includes a crystalline structure. The crystalline structure may be produced such that there is a uniform d-spacing between each of the crystalline lattices within the semi-conductive component, which promotes uniform exfoliation.

At step 402, at least an atomic layer of the semi-conductive component is exfoliated. The term “exfoliate,” as used herein refers to delaminating a layer of a component such that the layer has a thickness of about 1 atom. In an embodiment, an atomic layer may have any suitable length or width, e.g., about 100 nm to about 3 μm, while the thickness may be about 1 atom to about 10 atoms, e.g., about 1 atom to about 3 atoms, about 2 atoms to about 4 atoms, about 3 atoms to about 5 atoms, about 4 atoms to about 6 atoms, about 5 atoms to about 7 atoms, about 6 atoms to about 8 atoms, about 7 atoms to about 9 atoms, or about 8 atoms to about 10 atoms. The atomic layer may be exfoliated from the semi-conductive component according to one or more exfoliating techniques. For example, exfoliating techniques can include sonication, heat, chemical potential, electrochemical potential, and/or mechanical force. In an embodiment, sonication may include sonicating for less than 10 minutes at a high ultrasonic amplitude, e.g., about 80% to about 90%. In an embodiment, heating may include microwave-hydrothermal heating at short times, e.g., less than or equal to 30 seconds, and at high temperatures, e.g., greater than or equal to 150° C. Without being bound by theory by exfoliating an atomic layer of the semi-conductive component the surface area of the semi-conductive component may increase, which reduces the distance of proton diffusion and increases power output of the cathode.

In an embodiment, the atomic layer of the semi-conductive component may be exfoliated after introducing a chemical precursor, e.g., sodium dodecyl sulfate, sodium cholate, urea, sodium metaborate tetrahydrate, alkali metals and transition-metal halides, dimethylsulphoxide (DMSO), N-methyl-pyrrolidinone (NMP), N-vinyl-Pyrrolidinone (NVP), or supercritical carbon dioxide. Without wishing to be bound by theory the chemical precursor may increase the spacing between each of the atomic layers via intercalation by using Van der Waals interactions, to promote exfoliation of the semi-conductive component.

At step 403, the atomic layer of the semi-conductive component is arranged in an alternating orientation with a layer of a conductive component layer. In an embodiment, the layer of the conductive component layer may be an atomic layer of the conductive component. In an embodiment, the arrangement of the atomic layer of the semi-conductive component and the atomic layer of the conductive component may occur due to one or more of electrostatic interactions and/or steric effects. For example, a positive charge may exist in a first location of the atomic layer of the semi-conductive component, where a negative charge corresponding to a second location of the atomic layer of the conductive component may bind to the first location. In an embodiment, the arrangement may occur in one or more solvents, e.g., aqueous solvents, polar solvents, non-polar solvents, or organic solvent. The one or more solvents may be heated to a temperature of about 25° C. to about 80° C., e.g., about 25° C. to about 30° C., to about 30° C. to about 50° C., about 50° C. to about 70° C., or about 70° C. to about 80° C. Without being bound by theory, the arrangement of the atomic layer of the semi-conductive component and the atomic layer of the conductive component allows for thicker cathodes to be formed while maintaining a conductivity suitable for proton exchange in the battery. By increasing the thickness of the cathode an increase of the energy density occurs as more charge may be stored within the battery 100.

Overall, the present disclosure provides a nickel composites that implement a plurality of atomic sheets of a semi-conductive component and/or a conductive component, increasing the overall surface area of the composite. The increase in the overall surface area of the composite decreases a distance of proton diffusion, which increases power output of the composite. Additionally, the nickel composites provide an increase in energy density due to the arrangement of an atomic sheet of a semi-conductive component with a conductive component, which increases the maximum thickness of the nickel composite without reducing power output.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

Numerical ranges used herein include the numbers recited in the range. For example, the numerical range “from 1 wt % to 10 wt %” includes 1 wt % and 10 wt % within the recited range.

For the sake of brevity, only some ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All numerical values within the detailed description herein are modified by “about” the indicated value, and take into account experimental error and variations that would be expected by a person having ordinary skill in the art.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

The specific embodiments described herein have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112 (f). However, for any claims containing elements designated in any other manner, it is intended that such elements are not to be interpreted under 35 U.S.C. 112 (f).

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A nickel composite, the nickel composite comprising:
a first atomic layer of a semi-conductive component;
a second atomic layer of the semi-conductive component; and
a layer of a conductive component disposed between the first atomic layer and the second atomic layer.

2. The composite of claim 1, wherein the first atomic layer has a thickness of about 1 atom to about 10 atoms.

3. The composite of claim 1, wherein the second atomic layer has a thickness of about 1 atom to about 10 atoms.

4. The composite of claim 1, wherein the semi-conductive component is nickel hydroxide, or nickel oxyhydroxide.

5. The composite of claim 4, wherein the semi-conductive component is nickel hydroxide.

6. The composite of claim 4, wherein the semi-conductive component is nickel oxyhydroxide.

7. The composite of claim 1, wherein the layer of the conductive component comprises a thickness of about 10 Å to about 100 Å.

8. The composite of claim 1, wherein the layer of the conductive component is selected from the group consisting of: molybdenum disulfide, graphene, titanium disulfide, boron nitride, silver sulfate, two-dimensional inorganic compound, graphene, hexagonal boron nitride, or transition-metal dichalcogenides.

9. The composite of claim 8, wherein the layer of the conductive component is 1T-molybdenum disulfide.

10. The composite of claim 8, wherein the layer of the conductive component is graphene.

11. A method of forming a nickel-hydrogen battery electrode, the method comprising:
producing a semi-conductive component having a crystalline structure;
exfoliating the semi-conductive component to produce a plurality of atomic layers of the semi-conductive component; and
disposing at least a layer of a conductive component between each atomic layer of the plurality of atomic layers conductive components.

12. The method of claim 11, wherein the layer of the conductive component is an atomic layer of the conductive component.

13. The method of claim 11, wherein the atomic layer of the conductive component is produced using chemical exfoliation.

14. The method of claim 11, wherein each atomic layer of the plurality of atomic layers comprises about 1 to about 10 atoms of the crystalline structure of the semi-conductive component.

15. The method of claim 11, wherein each atomic layer of the plurality of atomic layers is exfoliated by sonicating the crystalline structure.

16. The method of claim 15, wherein sonicating comprises sonicating the crystalline structure at an ultrasonic amplitude of about 80% to about 90%.

17. The method of claim 11, wherein each atomic layer of the plurality of atomic layers is exfoliated by heating the crystalline structure.

18. The method of claim 17, wherein heating comprises microwave-hydrothermal heating at temperatures of greater 150° C.

19. The method of claim 11, wherein arranging further comprises:
disposing a first atomic layer of the plurality of atomic layers in a solvent;
disposing a second atomic layer of the plurality of atomic layers in the solvent;
disposing the layer of the conductive component in the solvent; and
heating the solvent to a temperature of about 25° C. to about 80° C.

20. The method of claim 11, wherein exfoliating the first atomic layer further comprises introducing a chemical precursor.
